(19) United States
(12) Patent Application Publication
(10) Pub. No.: US 2006/0047585 A1
(43) Pub. Date: Mar. 2, 2006

(54) Method and apparatus for viewing the visual properties of a gemstone on a packaging unit

(76) Inventors: Dave Lapa, Antwerpen (BE); Christiaan Louis Cecile Keersmaekers, Antwerpen (BE); Christian Marie Joseph Ghislain Cornille Lenaerts, Antwerpen (BE); Marc Frans Alida Van De Velde, Antwerpen (BE); Marti Guixe Roca, Antwerpen (BE)

Correspondence Address: KNOBBE MARTENS OLSON & BEAR LLP, 2040 MAIN STREET, FOURTEENTH FLOOR, IRVINE, CA, 92614, US

(21) Appl. No.: 10/996,881

(22) Filed: Nov. 24, 2004

(30) Foreign Application Priority Data
Aug. 26, 2004 (EP) 04255133.3

(51) Int. Cl. G06F 17/60

(52) U.S. Cl. 705/27

(57) ABSTRACT

A method of displaying a visual representation of a product on a packaging unit arranged to contain the product, the packaging unit comprising a display device, a memory device and a memory port arranged to hold the memory device, the method comprising the steps of: storing information related to the product in the memory device; fitting the memory device into the memory port; and arranging the display device to display the stored information.

### FIELD OF THE INVENTION

The present invention relates to a method or apparatus for packaging a gemstone. More particularly, the present invention relates to a method or apparatus for viewing the visual properties of a gemstone on a packaging unit.

### DESCRIPTION OF THE RELATED TECHNOLOGY

In known packaging systems, the product for sale is usually placed within a packaging unit and displayed on a shelf within a shop. The packaging unit may be of various shapes, sizes and made from many different materials. For example, the packaging unit may be a box type package with a lid and made of a plastic type material. The product for sale would be placed inside the box, and the box would be sealed by closing the lid. A generic image of the product would be placed on the external surfaces of the box to indicate to the consumers the type of product that is located within the box.

One problem associated with this kind of packaging is that the consumer cannot see what is inside the packaging unit unless the packaging unit is either opened or made from a transparent material. It is not always convenient to use a transparent packaging material for various reasons such as, for example, the transparent material is too expensive and is not malleable enough to form a packaging shape. Even if a transparent material were used, the consumer cannot easily identify important visual features of the product inside the box in order to help them decide whether the product is the right product for them.

For example, in the case of a visually aesthetically pleasing product, such as a gemstone, it may not be possible to determine an accurate and realistic visual representation of the gemstone's visual features clearly through the transparent packaging.

A further problem is that the images shown on the external surfaces of the packaging units are not of the actual product that is to be located inside the packaging unit. The pictures are usually of a generic idealised version of the product in order to seduce the customer into purchasing the product, and not an accurate visual representation of the product to be placed within the packaging unit. This can lead to the consumer being misled and so becoming upset causing a loss in revenue due to the loss of goodwill.

When selling a product such as a gemstone, for example diamonds, the gemstones are usually placed inside a glass cabinet on a display pad for consumers to visually compare the gemstones in order to make a decision as to which gemstone they wish to purchase. Upon making this decision, the gemstone is removed from the display case, polished and placed inside a jewellery box for the consumer to take away.

The beauty of gemstone, such as a cut diamond, derives from its light handling ability. What attracts the eye is the “game of light” played by a well cut diamond as incident light is reflected and refracted off its many facets. Diamonds and other gemstones have been cut, polished and worn as jewellery for thousands of years. They may be cut according to many different cut patterns such as the round brilliant, oval, pear, marquise, radiant, princess, heart, emerald cut etc. The most popular cut today is known as the standard round and brilliant (SRB) cut.

When purchasing a gemstone, such as a cut diamond, an untrained observer typically relies on the skill and knowledge of the jeweller to explain the differences between one gemstone and another. When describing a cut diamond to an untrained observer, the jeweller may refer to what are known as the four C's; that is, its carat weight, clarity, colour and cut. Each of these factors has an effect on the value of the diamond. Of these factors, the effect of carat weight is relatively straightforward for the untrained observer to understand. That is, the value of a cut diamond generally increases with increasing carat weight. Similarly, the effects of clarity (clear diamonds are generally more valuable than less clear diamonds) and the colour (colourless diamonds are generally move valuable than coloured diamonds) are relatively straightforward for the untrained observer to understand.

However, it is the cut of a diamond, and its dramatic effect of light handling ability, that has the most significant effect on value. Diamond cutting and polishing is a highly skilled art and a well cut diamond will command a significant price premium over an otherwise identical but poorly cut diamond. However, given the theoretical complexity of the effect of cut on the optical performance of a gemstone, it is hardly surprising that it is the most difficult factor for a jeweller to explain to an untrained observer.

In order to describe light handling abilities of cut gemstones, subjective parameters such as brilliance (the intensity of light returned), scintillation (fast, local fluctuation in the light returned as the diamond moves relative to the lighting conditions), symmetry (the symmetry of light patterns such as the so called “hearts and arrows”) and fire (the dispersion of white light into spectral colours) are used.

One problem associated with the selling of gemstones is that the consumer cannot obtain a good visual comparison between two gemstones situated side by side within a glass cabinet. Neither can two gemstones be easily compared visually side by side when they are located inside their respective jewellery boxes.

Further, after the gemstones have been purchased by the customers, it is not easy for two customers to compare the visual characteristics of the gemstones with each other, unless they remove the gemstones from the packaging units and hold them up to an identical light source simultaneously.

The present invention aims to overcome or at least alleviate some or all of the aforementioned problems.

### SUMMARY OF CERTAIN INVENTIVE ASPECTS

In one aspect, the present invention provides a method of displaying a visual representation of a product on a packaging unit arranged to contain the product, the packaging unit comprising a display device, a memory device and a memory port arranged to hold the memory device, the method comprising the steps of: storing information related to the product in the memory device; fitting the memory device into the memory port; and arranging the display device to display the stored information.

In a further aspect, the present invention provides a packaging unit arranged to contain a product, the packaging unit comprising a display device and a memory port for use with a memory device, the memory device arranged to store information related to the product and the display device arranged to display the stored information.

In yet a further aspect, the present invention provides first packaging means comprising a second packaging means for holding a gemstone, the first packaging means further comprising a memory means for storing information associated with the visual appearance of the gemstone, and a display means for displaying the stored information as a moving image.

In yet a further aspect, the present invention provides a packaging means for holding a gemstone, the packaging means comprising a memory means for storing information associated with the visual appearance of the gemstone, and a display means for displaying the stored information as a moving image.

The present invention has the advantage of providing the ability to view a moving image of the actual product associated with the packaging unit, thus allowing consumers the ability to view the product's visual features in detail without the need to see the actual product associated with the packaging unit. This in turn provides an aid to selling the product in a shop through the comparison of products against other products as well as providing a means to assess the subjective beauty of an individual product stored inside a packaging unit.

Further, the invention provides the advantage of allowing consumers to easily compare visual images of the product after purchasing the product and leaving the shop premises. For example, consumers who have bought diamonds at different times may visually compare the cut of their diamonds without the need to remove the diamonds from the packaging, in order to see which diamond is the best.

Further, the present invention provides the advantage of catching the attention of passers-by walking past a shop window. Alternatively, the present invention provides the advantage of catching the attention of browsers entering a large shopping environment. Passers-by and browsers would be attracted to the visual representation of the product's image being shown upon the packaging unit and so would approach the products being displayed in order to obtain further information.

### BRIEF DESCRIPTION OF THE DRAWINGS

Specific embodiments of the present invention will now be described by way of example only, with reference to the accompany drawings, in which:

FIG. 1 shows a block diagram of a data and image transfer process;

FIG. 2 shows a block diagram of a circuit used according to an embodiment of the present invention;

FIG. 3 shows a packaging unit according to an embodiment of the present invention;

FIG. 4 shows the internal component of the packaging unit shown in FIG. 3;

FIG. 5 shows the packaging unit shown in FIGS. 3 and 4 being used to store a gemstone;

FIG. 6 shows numerous packaging units as shown in FIG. 5 being displayed;

FIGS. 7A and 7B show a display box packaging unit according to another embodiment of the present invention;

FIG. 8 shows a further embodiment of the packaging unit;

FIG. 9 shows yet a further embodiment of the packaging unit;

FIG. 10 shows the display box packaging unit as shown in FIG. 7 being used;

FIG. 11 shows the display box packaging unit of FIG. 7 and the packaging unit of FIG. 3 being used.

### DETAILED DESCRIPTION OF CERTAIN INVENTIVE EMBODIMENTS

Referring to the applicant's earlier patent applications, U.S. Pat. No. 6,786,733, hereby incorporated by reference, describes a computer implemented method of and system for teaching an untrained observer to evaluate a gemstone. Further, granted European patent EP 1319942 discloses an apparatus for generating data for determining a property of a gemstone and methods and computer programs for determining a property of a gemstone.

These prior patent applications describe how a number of images of the gemstone are captured at different rotational positions whilst shining a light source on the gemstone. For example, the images are captured at 2° intervals over a 90° range, thus providing 45 images. These images are used to show visually to the consumer certain light characteristics of the gemstone, such as scintillation.

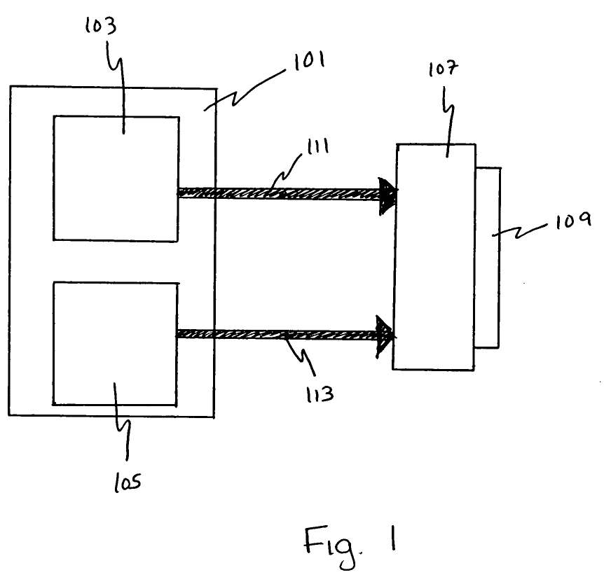

Referring to FIG. 1, a personal computing device 101 is shown. The personal computer 101 runs a standard operating system, such as Microsoft Windows XP or the like. Images are captured and stored by the image capture device as described in the applicant's previous patent applications. A camera captures the images and stores them as bitmap files. The PC 101 stores the bitmap files showing images of the gemstone in a scanned files store 103. Further, the PC 101 includes a database 105 for storing data associated with the gemstone, such as a unique identification number or carat weight of the gemstone.

Using a memory device port 107 with a memory device 109 located within the port 107, the scanned files within the scanned files store 103 are transferred from the scanned files store 103 to the memory device 109 along the scanned file communications channel 111. The communications channel may be any suitable data communications medium, for example, the PCI/XIO interface.

Further, the data held within the database 105 is transferred along a data file communications channel 113 into the memory device 109.

In this embodiment, the memory device is a Sony Memory Stick (MS) flash memory card, but may be any other suitable memory device.

After the above-described procedure, the memory device 109 contains bitmap images of the gemstone along with data associated with that gemstone.

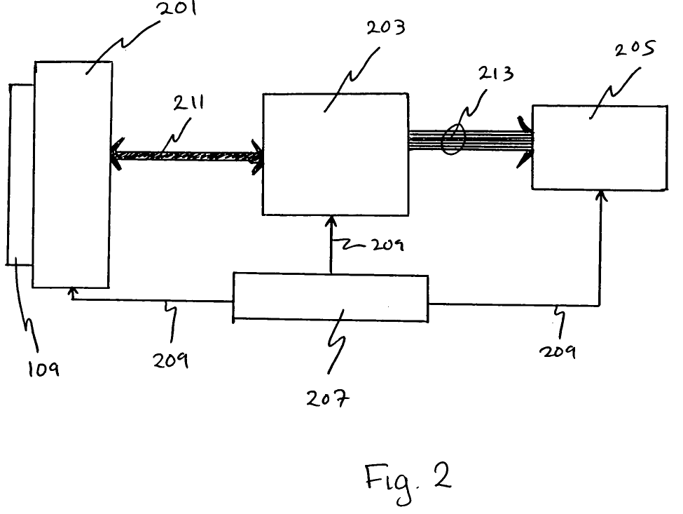

Referring to FIG. 2, a block diagram is shown of a circuit used in this embodiment. The memory device 109 (with the stored bitmap images and stored data) is inserted within a packaging unit memory device port 201. The packaging unit memory device port 201 is connected to a display microcontroller 203 via a first data channel 211. The display microcontroller 203 is connected to a display device 205 via a second data channel 203. The packaging unit memory device port 201, display microcontroller 203 and display device 205 are provided with power from a power supply 207 along power supply lines 209.

The display device in this embodiment is a liquid crystal display. The liquid crystal display is a transmissive (i.e. the pixels are illuminated from behind the screen) active matrix thin film transistor (TFT) type of display. However, any other suitable type of display could be used.

The display microcontroller 203 in this embodiment is a Nexperia PNX1500 available from Philips Semiconductors.

The packaging unit memory device port 201 is any suitable memory device port used with a memory stick type memory device 109. Any other suitable memory port can be used in conjunction with other types of memory devices.

The power supply 207 is a small high-powered battery unit such as a lithium ion battery.

The display microcontroller 203 receives the data from the memory device 109 connected to the packaging unit memory device port 201, via the first data channel 211. The display microcontroller 203 outputs the gemstone image data (bitmaps) and data files (text) in a suitable format along the second data channel 213 to be displayed upon the display device 205. In this embodiment, the second data channel 213 is a TTL-RGB output of the PNX1500. The display device 205 is then able to sequentially display the stored bitmap images of the gemstone alongside the data associated with that gemstone, for example its unique identification number.

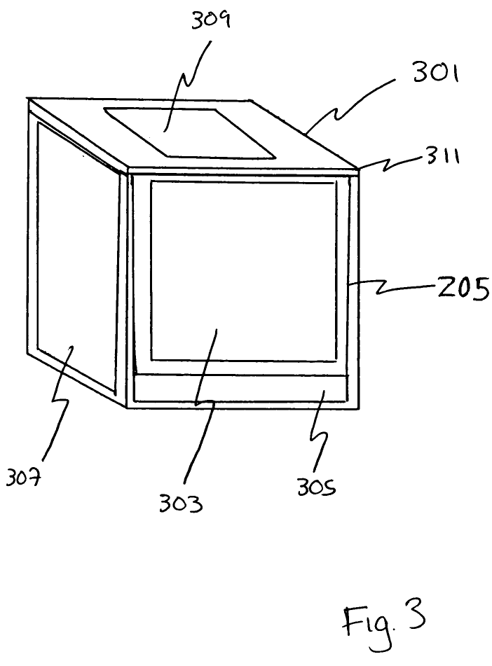

Referring to FIG. 3, a packaging unit 301 is shown according to this embodiment. The packaging unit 301 is the size of a standard jewellery box used to store a gemstone (not shown). The packaging unit 301 includes a display device 205 of the type previously described. The display device 205 has a first display area 303 and a second display area 305. The first display area 303 is used to show the stored sequential images of the gemstone associated with the packaging unit. The second display area 305 is used to display the stored data associated with that same gemstone.

The packaging unit 301 also includes an information area 307 whereby information related to the product may be printed on the packaging unit 301. For example, in this embodiment the information shown in the information area 307 includes the certified characteristics of the gemstone associated with the packaging unit 301.

Further, a quality label 309 may be attached to the packaging unit 301 in order to identify the producer of the gemstone. This quality label assures the consumer that the product is coming from a reputable and recognisable producer.

Located at the top of the packaging unit 301 is a lid 311. The lid 311 is opened up in order to insert and remove the gemstone from the packaging unit 301. In this embodiment the lid 301 is hinged at one side, however it will be understood that any suitable type of lid may be used.

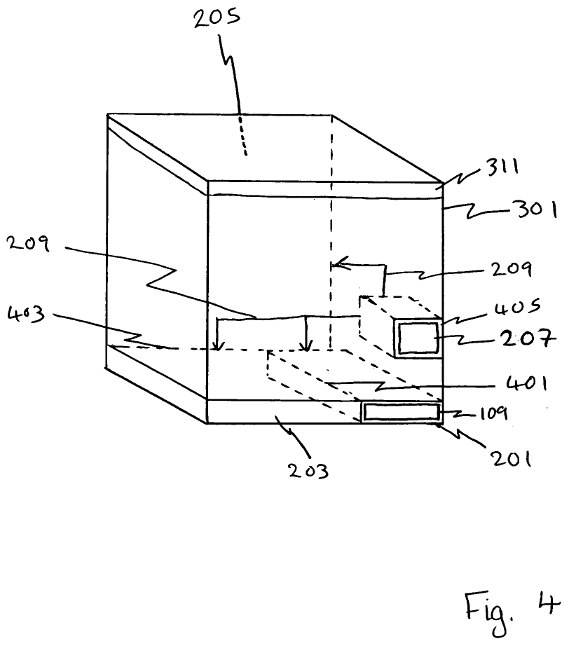

FIG. 4 shows the internal components of the packaging unit 301 described above. Located at the base of the packaging unit 301 is the packaging unit memory device port 201. The memory device 109 is inserted through the opening of the device port 201 and fitted into place. Also located in the base of the packaging unit 301 is the display microcontroller 203. The display microcontroller 203 is interconnected to the packaging unit memory device port 201 via the interface connections 211 forming the first data channel 211.

At the front of the packaging unit 301 is located the display device 205 on the external front surface of the packaging unit 301, as described above.

In this embodiment, the liquid crystal display (LCD) device 205 is attached to the packaging unit using a suitable adhesive. The display device 205 is sufficiently light in weight for it to be securely fastened to the packaging unit.

The display microcontroller 203 is interconnected to the display device 205 via interface connections 403, thus connecting the second data channel 213 between the two components (203, 205).

Also located within the packaging unit 301 is a battery compartment 405 arranged to accept the power supply device 207 of the type described above. The power outputs of the power supply device 207 are connected to the display device 205, the display microcontroller 203 and the packaging unit memory device port 201 via the power supply lines 209.

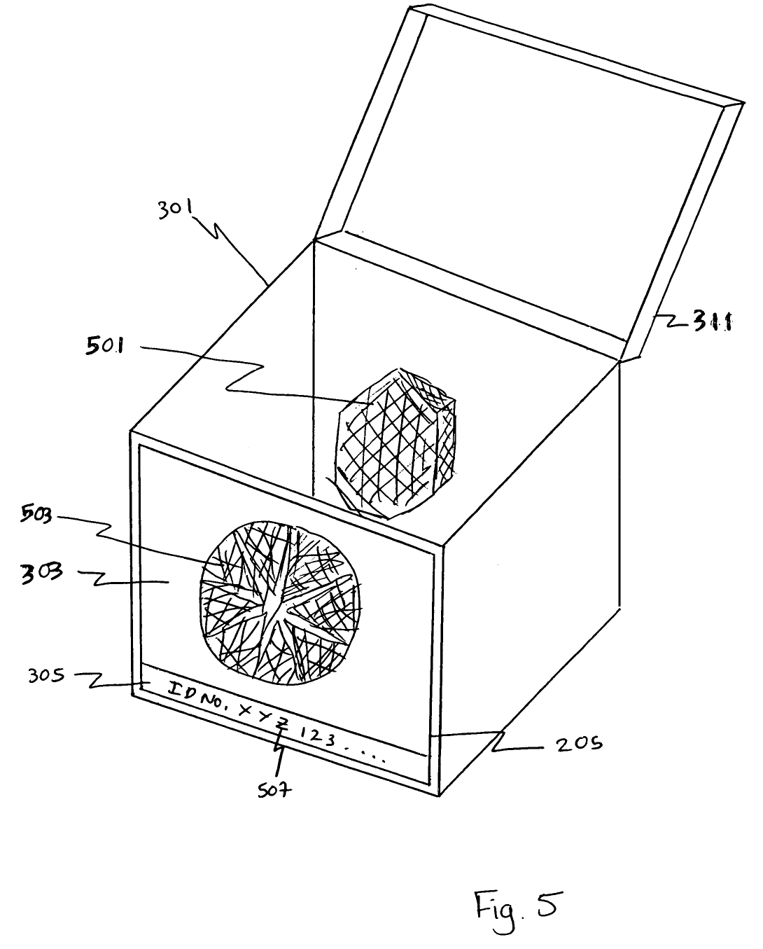

FIG. 5 shows one example of how the packaging unit 301 may be used in conjunction with a gemstone 501. The packaging unit 301 has the gemstone 501 located within it. On the front of the packaging unit 301 is the display device 205 incorporating the first display area 303 and the second display area 305. The first display area 303 on the display device 205 shows a moving image of the actual gemstone located within the packaging unit 301. The moving image 503 is the image taken previously and stored on the memory device 109 as described above. In this embodiment the moving image is displayed using 45 consecutive bitmap images stored in the memory device 109. After the 45^{th} image is displayed, the display microcontroller 203 is arranged to display the images again, starting from image No. 1 such that the image 503 is played in a loop.

The packaging unit 301 incorporates a lid 311, which, upon placing the gemstone 501 into the packaging unit 301, is closed. The consumer who has purchased the gemstone 501 may take the packaging unit 301 away with them. The consumer then at any time may view the optical characteristics of the gemstone 501 as shown on the display device 205 as a moving image 503 at any time without removing the gemstone 501 from the packaging unit 301.

In addition to the display of the moving image 503, data associated with the gemstone 501 is displayed in the second display area 305. Data including the unique identification number 507 of the gemstone and carat weight, for example, is displayed next to the moving image 503. The data information is scrolled across the second display area 305 in this embodiment.

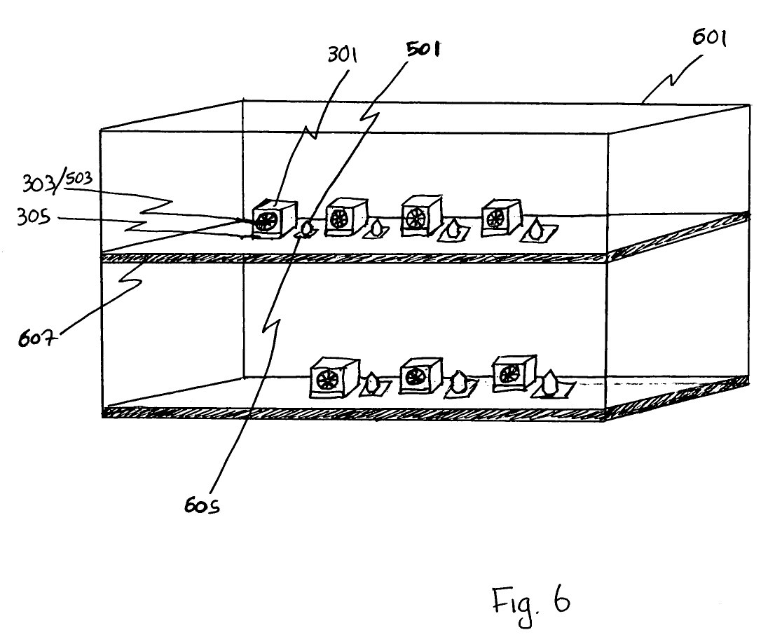

FIG. 6 shows an example of the packaging unit 301 being used within a shop environment. A number of the packaging units 301 are placed inside a glass case 601 upon a shelf unit 607. Alongside each of the packaging units 301 is placed the gemstone 501 associated with that packaging unit 301 upon a gemstone holder 605. Each of the packaging units 301 displays the moving image of the associated gemstone 503 upon the first display area 303 of the display device 205. In addition to displaying the moving image 503 of the gemstone 501, data associated with the gemstone 501 is displayed in the second display area 305 as described above.

Therefore, consumers entering the shop intending to purchase a gemstone may view the optical characteristics of each gemstone by viewing the moving image 503 on the display device 205 on each packaging unit 301 in order to more easily distinguish the difference in visual characteristics of the gemstones, and so determine which gemstone 501 they wish to purchase. The act of placing together the many packaging units 301 allows the consumer to make a visual comparison in real time of different gemstone's visual characteristics. This gives the consumer a real sense of choice by attracting the consumer and seducing them with the visible scintillation of the gemstones being displayed.

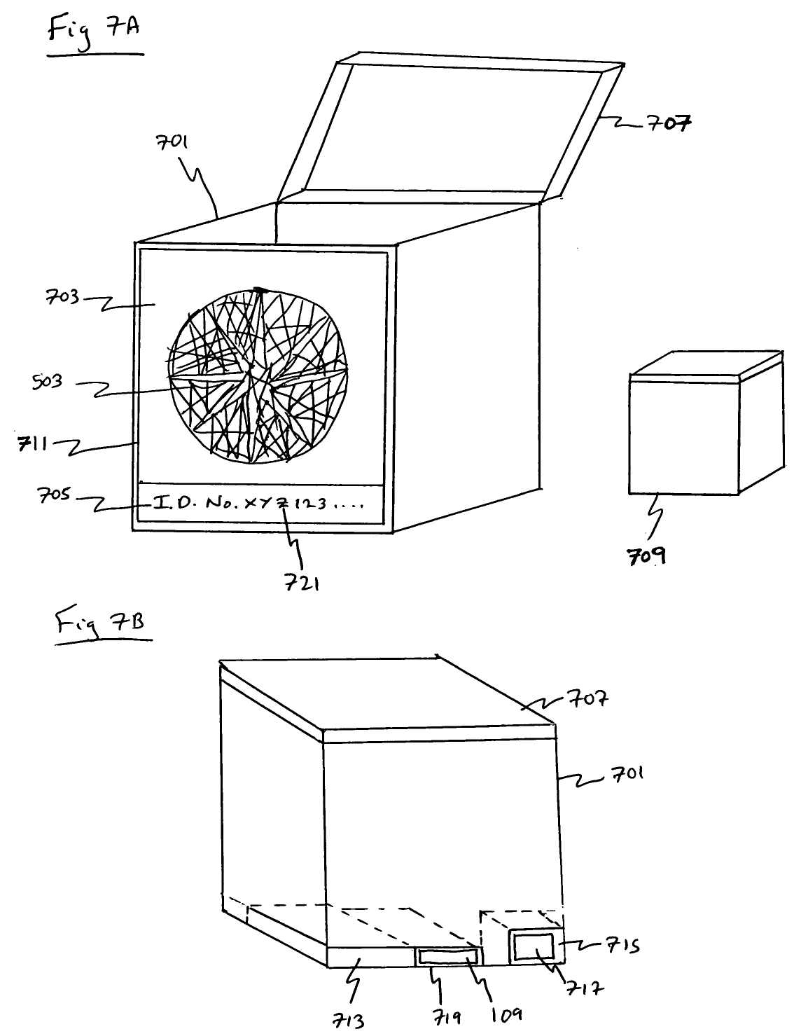

FIG. 7A shows a different embodiment of a packaging unit 701 intended for use as a display box. The display box packaging unit 701 is larger than the jewellery box type packaging unit 301 previously described.

The display box packaging unit 701 includes similar components to that of the jewellery box type packaging unit 301 as shown in FIG. 7B and discussed below. A display device 711 is affixed to the front face of the display box packaging unit 701 using, in this embodiment, for example, a suitable adhesive.

The display box packaging unit 701 includes, within a base compartment, a display micro controller 713, a battery compartment 715 arranged to accept a power supply device 717, a memory device port 719 arranged to accept a memory device 109. These components are connected together in a similar fashion to the previous embodiment.

The display 711 includes a first display area 703 and a second display area 705. As in the jewellery box packaging unit 301 described above, the first display area 703 displays a moving image of 503 of a gemstone associated with the display box packaging unit 701. In the second display area 705, data associated with that gemstone is displayed. For example, the ID number 721 and carat weight etc are scrolled across the second display area 705.

As the moving image 503 is shown on the front surface of the display box packaging unit 701, the display boxes 701 may be stacked inside a glass case allowing consumers to view the moving image of the gemstone (not shown) within the packaging unit 701 from the front of the packaging unit 701.

A standard jewellery box 709 including a gemstone (not shown) fits inside the display box packaging unit 701 along with a folder including the quality guarantee associated with the gemstone, a gemstone certificate and an information folder providing the consumer information associated with their purchase.

Upon purchasing the gemstone the consumer takes away the display box packaging unit 701 along with the above mentioned items.

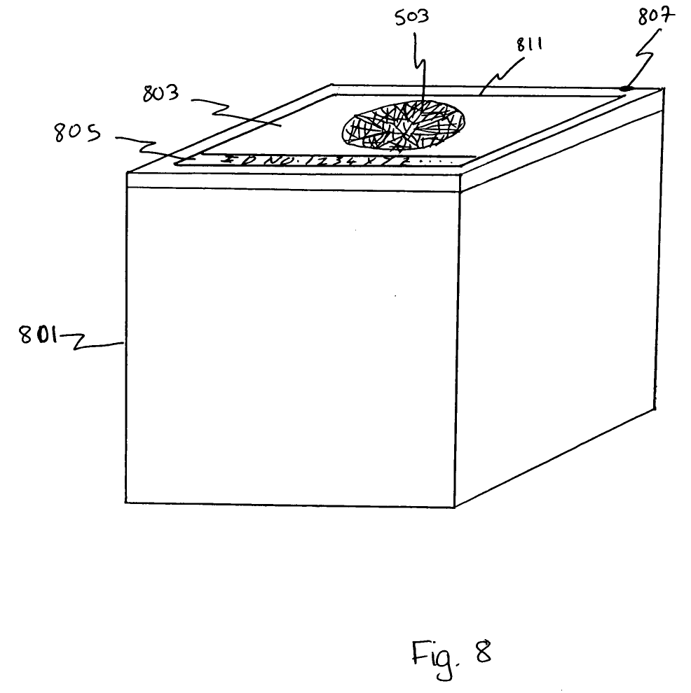

A further embodiment of a packaging unit 801 is shown in FIG. 8. This packaging unit 801 may be of the type depicted in FIGS. 3, 4, 5 and 6, or alternatively may be of the type depicted in FIG. 7.

The packaging unit 801 includes a display device 811 fixedly attached to the outer surface of the lid 807 of the display box packaging unit 801 using a suitable adhesive.

As in the previous embodiments, the display device 811 incorporates a first display area and a second display area 805, wherein the first display area 803 shows a moving image 503 of the gemstone (not shown) associated with the packaging unit 801, and the second display area 805 shows data associated with the gemstone.

As the moving image 503 is located on the top surface of the lid 807 attached to the packaging unit 801, the display box 801 may be placed within a glass display unit such that the consumers can view the moving image 503 from above.

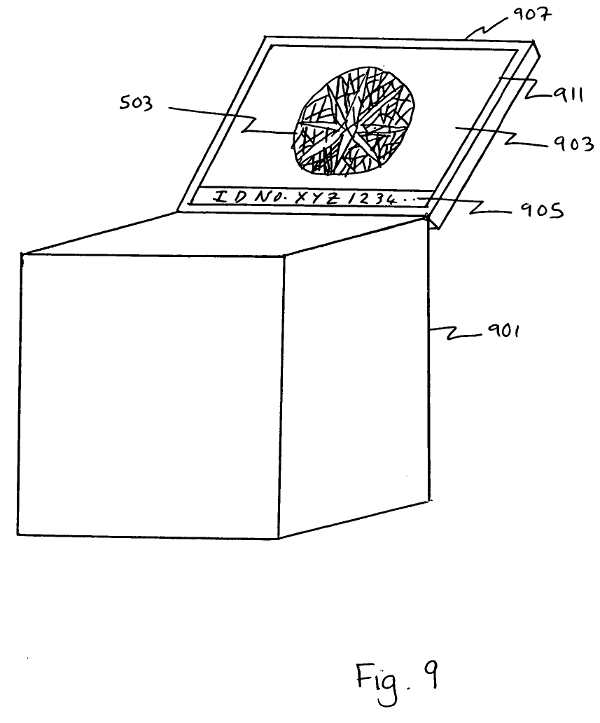

FIG. 9 shows a further embodiment of a packaging unit. This packaging unit 801 may be of the type depicted in FIGS. 3, 4, 5 and 6, or alternatively may be of the type depicted in FIG. 7.

The packaging unit 901 includes a lid 907, with a display device 911 attached on the inside surface of the lid 907 using a suitable adhesive. The display device 911 is therefore visible when the lid 907 is in an open position.

As in the above embodiments, the display device 911 incorporates two display areas, a first display area 901 for showing the moving image 503 and a second display area 905 for showing the data associated with the gemstone.

In this configuration, a user will be able to view the moving image of the gemstone located inside the packaging unit 901 whilst also being able to view the other contents of the packaging unit 901, such as the gemstone in the case of the jewellery box packaging unit embodiments shown in FIGS. 3, 4, 5 and 6, or the folder incorporating the quality guarantee, diamond certificate and information folder in the case of the display box packaging unit embodiment shown in FIG. 7.

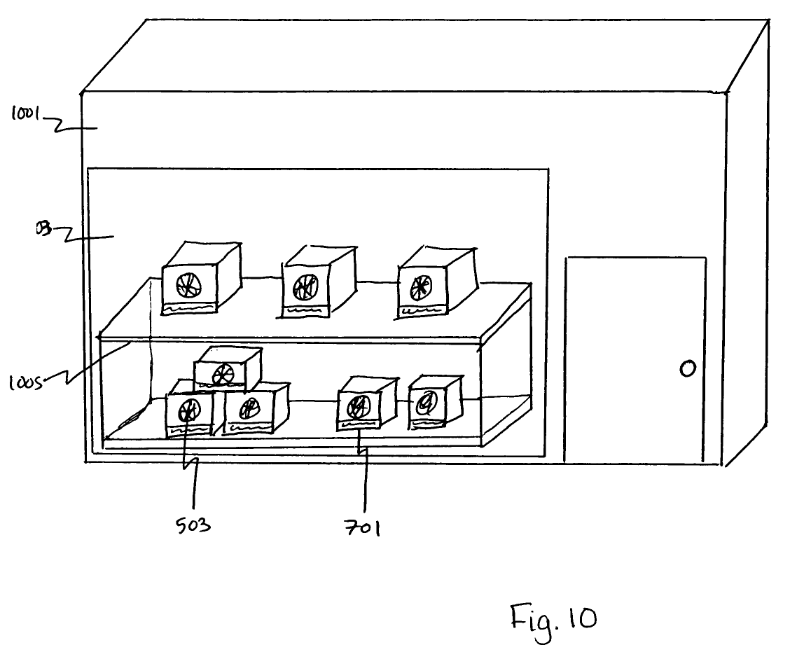

FIG. 10 shows a scenario wherein the display box packaging unit 701 discussed above is used in a shop window. The display box packaging unit 701 is located on a shelf unit 1005 within a shop window 1003 of a shop 1001 selling gemstones. The moving images 501 of the gemstones stored within the display box packaging unit 701 catch the eye of passers-by such that potential consumers are encouraged to enter the shop 1001 in order to find out further information concerning the gemstones being sold.

The consumer would easily be able to stand outside the shop 1001 and visually compare different gemstones located within the display box packaging unit 701 without having to actually view the particular gemstones themselves. This provides an additional advantage that the expensive gemstones do not have to be displayed in a shop window in order to entice consumers into the shop, and so the security risk of having the gemstones stolen by smashing the window is reduced.

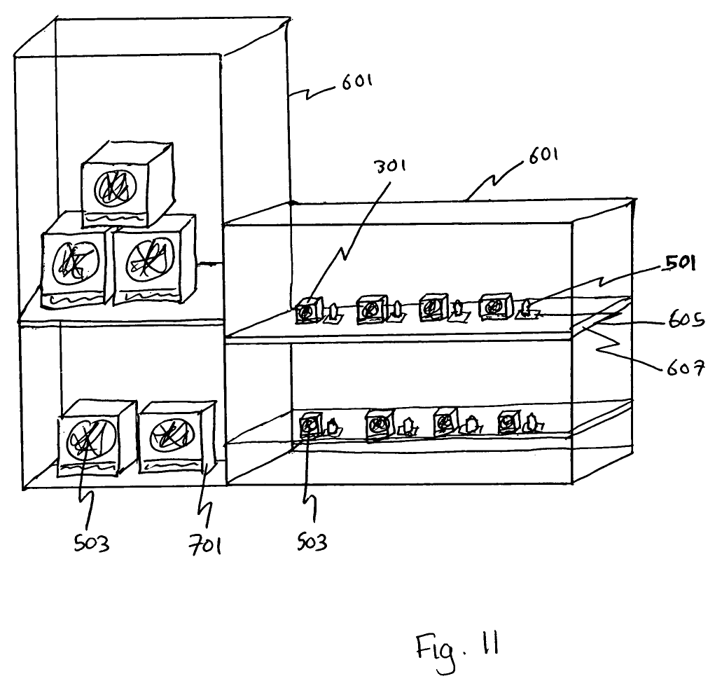

FIG. 11 shows a scenario whereby the display box packaging unit 701 and the jewellery box type packaging unit 301 are used in conjunction with each other. The jewellery box type packaging units 301 are located within a glass case 601 upon a self 607 alongside their associated gemstones 501, which are positioned upon gemstones holders 605. Moving images of these gemstones are displayed upon the front surface of the jewellery type packaging unit 301. Alternatively, the moving image may be displayed on the top surface (i.e. the lid) of the packaging unit.

In addition, display box packaging units 701 are located alongside in a further glass case 601, wherein the gemstones are located inside the display box packaging units 701 within their individual jewellery boxes. A moving image 503 shows the visual characteristics of the gemstones located therein.

This arrangement is such that consumers within a large shopping area would notice the visual moving display of the display box packaging units 701 and then be able to view moving images 503 of additional gemstones associated with the smaller packaging units 301.

It will be understood that embodiments of the present invention are described herein by way of example only, and that various changes and modifications may be made without departing from the scope of the invention.

For example, the various configurations of the display device shown in FIGS. 7, 8 and 9 for the display box type packaging unit may also be applied to the jewellery type packaging unit 301 discussed in the first embodiment. For example, the display device may be attached to the lid, internally or externally, of the jewellery type packaging unit 301.

Further, any type of suitable display device may be used and attached to the packaging units in any suitable manner. For example, the display may be a black and white liquid crystal display, a passive matrix display such as a colour super twist nematic or double layer super twist nematic device. Further, the liquid crystal display could be a reflective type liquid crystal display.

It will also be clear that any suitable memory device may be used such as the secure digital (SD) memory device, multi media card (MMC) memory device, compact flash (CF) card type 1 and 2, smart media (SM) card and XD card.

In fact, a non-removable memory could be used, and a data port such as an RS-232 or USB port, or a wireless device such as a Bluetooth or Infrared receiver, could be provided on the box, for supplying the image data to the memory.

Any suitable microcontroller may be used to read the data and images from the memory type device and output them in a suitable format to display the information on a liquid crystal display.

Any suitable type of small high power battery unit may be used. For example, the battery unit may be a rechargeable type unit.

Further, it will be clear that, although in the embodiments the moving images are made by showing a series of stored bitmap files sequentially on the display device, the moving image may be produced by storing a file in a video format on the memory device. For example, suitable formats such as MPEG, AVI and DV format may be used.

What is claimed is:

1. A method of displaying a visual representation of a product on a packaging unit arranged to contain the product, the packaging unit comprising a display device, a memory device and a memory port arranged to hold the memory device, the method comprising the steps of:
retaining information related to the product in the memory device;
fitting the memory device into the memory port; and
arranging the display device to display the stored information.

2. The method of claim 1 wherein the stored information comprises a plurality of stored electronic images providing a visual representation of the product.

3. The method of claim 1 wherein the stored information comprises a video file providing a visual representation of the product.

4. The method of claim 1 further comprising the step of displaying the stored information as a moving image of the product.

5. The method of claim 1, wherein the stored information comprises data associated with the product.

6. The method of claim 5, wherein the data includes at least an identification number uniquely identifying the product.

7. The method of claim 1 wherein the product is situated outside of the packaging unit.

8. The method of claim 1 wherein the product is situated inside the packaging unit.

9. The method of claim 1 wherein the packaging unit further comprises certification information associated with the product.

10. The method of claim 1 wherein the product has visually aesthetic properties.

11. The method of claim 10 wherein the product is a gemstone.

12. The method of claim 11 wherein the gemstone is a diamond.

13. The method of claim 12 wherein the stored information comprises image information showing the scintillation of the diamond.

14. The method of claim 1 further comprising the steps of arranging a plurality of said packaging units next to each other.

15. The method of claim 1 wherein the packaging unit further comprises a lid and the display device is attached to the lid such that the display device is visible when the lid is open.

16. The method of claim 1 wherein the packaging unit further comprises a lid, and the display device is attached to the lid such that the display device is visible when the lid is closed.

17. A packaging unit arranged to contain a product, the packaging unit comprising a display device and a memory port for use with a memory device, the memory device arranged to store information related to the product and the display device arranged to display the stored information.

18. The packaging unit of claim 17 wherein the stored information comprises a plurality of stored electronic images providing a visual representation of the product.

19. The packaging unit of claim 17 wherein the stored information comprises a video file providing a visual representation of the product.

20. The packaging unit of claim 17 wherein the stored information is displayed as a moving image of the product on the display device.

21. The packaging unit of claim 17 wherein the stored information comprises data associated with the product.

22. The packaging unit of claim 21 wherein the data comprises at least an identification number uniquely identifying the product.

23. The packaging unit of claim 17 further comprising the product located within the packaging unit.

24. The packaging unit of claim 17, further comprising certification information associated with the product.

25. The packaging unit of claim 17 wherein the product has visually aesthetic properties.

26. The packaging unit of claim 25 wherein the product is a gemstone.

27. The packaging unit of claim 26 wherein the gemstone is a diamond.

28. The packaging unit of claim 27 wherein the moving images show the scintillation of the diamond.

29. The packaging unit of claim 17 further comprising a lid, the lid comprising an inner surface, wherein the display device is attached to the inner surface of the lid such that the display device is visible when the lid is open.

30. The packaging unit of claim 17 further comprising a lid, the lid comprising an outer surface, wherein the display device is attached to the outer surface of the lid such that the display device is visible when the lid is closed.

31. A first packaging means comprising a second packaging means for holding a gemstone, the first packaging means further comprising a memory means for storing information associated with the visual appearance of the gemstone, and a display means for displaying the stored information as a moving image.

32. The first packaging means of claim 31 further comprising additional information related to the gemstone.

33. A packaging means for holding a gemstone, the packaging means comprising a memory means for storing information associated with the visual appearance of the gemstone, and a display means for displaying the stored information as a moving image.

34. A display system comprising (the first packaging means of claim 31 and the packaging means of claim 33) wherein the moving images are displayed in a manner that will catch the eye of a consumer upon entering a gemstone vendor's premises.

35. A display system comprising the first packaging means of claim 31 wherein the moving images are displayed in a manner that will catch the eye of a consumer walking past a gemstone vendor's premises.
